(19) United States
(12) Patent Application Publication
(10) Pub. No.: US 2024/0136670 A1
(43) Pub. Date: Apr. 25, 2024

(54) ELECTRODE ASSEMBLY AND BATTERY

(71) Applicant: ZHUHAI COSMX BATTERY CO., LTD., Zhuhai (CN)

(72) Inventor: Ning PENG, Zhuhai (CN)

(73) Assignee: ZHUHAI COSMX BATTERY CO., LTD., Zhuhai (CN)

(21) Appl. No.: 18/400,967

(22) Filed: Dec. 29, 2023

Related U.S. Application Data
(63) Continuation-in-part of application No. PCT/CN2022/132895, filed on Nov. 18, 2022.
Application No. PCT/CN2022/132895 is a continuation-in-part of application No. PCT/CN2022/132888, filed on Nov. 18, 2022.
Application No. PCT/CN2022/132888 is a continuation-in-part of application No. PCT/CN2022/132898, filed on Nov. 18, 2022.

(30) Foreign Application Priority Data
Nov. 18, 2021 (CN) 202111370461.4
Nov. 18, 2021 (CN) 202111370463.3
Nov. 18, 2021 (CN) 202111372454.8

(51) Int. Cl. H01M 50/531; H01M 10/0587

(52) U.S. Cl. CPC H01M 50/531; H01M 10/0587

(57) ABSTRACT

An electrode assembly includes at least two electrode plates stacked on each other; the first electrode plate is provided with a first groove, and the first current collector is connected to a first tab in the first groove; the second electrode plate is provided with a first avoidance groove, and the first avoidance groove and the first groove are disposed opposite to each other along a stacking direction of the electrode plates; and the first tab is completely covered by a projection of the first avoidance groove on the first electrode plate. Due to arrangement of an avoidance groove, an increase in a thickness of an electrode assembly caused by a tab may be reduced, so that the thickness of the electrode assembly can be reduced, reducing a volume of the electrode assembly, and further improving an energy density of a battery.

### CROSS-REFERENCE TO RELATED APPLICATIONS

The present application is a continuation-in-part of International Application No. PCT/CN2022/132888, filed on Nov. 18, 2022, a continuation-in-part of International Application No. PCT/CN2022/132898, filed on Nov. 18, 2022, and a continuation-in-part of International Application No. PCT/CN2022/132895, filed on Nov. 18, 2022. The International Application No. PCT/CN2022/132888 claims priority to Chinese Patent Application No. 202111370461.4, filed on Nov. 18, 2021, the International Application No. PCT/CN2022/132898 claims priority to Chinese Patent Application No. 202111372454.8, filed on Nov. 18, 2021, and the International Application No. PCT/CN2022/132895 claims priority to Chinese Patent Application No. 202111370463.3, filed on Nov. 18, 2021. All of the aforementioned applications are hereby incorporated by reference in their entireties.

### TECHNICAL FIELD

The present application relates to the field of battery technologies, and in particular, to an electrode assembly and a battery.

### BACKGROUND

A lithium-ion battery has advantages of large capacity, small volume, light weight, environmental protection and the like, and is widely applied to industries such as digital electronic products and electric vehicles. However, when an electrode assembly used for the lithium-ion battery is prepared, a thickness of a partial area of the electrode assembly may be relatively large, resulting in a relatively low energy density of a battery.

### SUMMARY

In view of the above problems, embodiments of the present application provide an electrode assembly and a battery, which can reduce a thickness of a partial area of the electrode assembly, thereby improving an energy density of the battery.

According to a first aspect, embodiments of the present application provide an electrode assembly, which includes: at least two electrode plates stacked on each other, two adjacent electrode plates have opposite polarities, the two adjacent electrode plates include a first electrode plate and a second electrode plate, the first electrode plate includes a first current collector and a first active material layer, the first current collector includes a first surface and a second surface that are disposed opposite to each other, the first surface and the second surface are covered by the first active material layer, the second electrode plate includes a second current collector and a second active material layer, the second current collector includes a third surface and a fourth surface that are disposed opposite to each other, and the third surface and the fourth surface are covered by the second active material layer; the first electrode plate is provided with a first groove, a slot of the first groove is located on a surface, away from the first current collector, of the first active material layer on the first surface, a bottom wall of the first groove is the first surface, and the first current collector is connected to a first tab in the first groove; the second electrode plate is provided with a first avoidance groove, a slot of the first avoidance groove is located on a surface, away from the second current collector, of the second active material layer on the fourth surface, a bottom wall of the first avoidance groove is the fourth surface, and the first avoidance groove and the first groove are disposed opposite to each other along a stacking direction of the electrode plates; and the first tab is completely covered by a projection of the first avoidance groove on the first electrode plate.

According to a second aspect, embodiments of the present application provide a battery, which includes the electrode assembly in the first aspect.

In the electrode assembly provided in the embodiments of the present application, the first electrode plate in the two adjacent electrode plates is provided with the first groove, the first current collector is connected to the first tab in the first groove, the second electrode plate in the two adjacent electrode plates is provided with the first avoidance groove, the first avoidance groove and the first groove are disposed opposite to each other along the stacking direction of the electrode plates, and the first tab is completely covered by the projection of the first avoidance groove on the first electrode plate. Due to arrangement of the first avoidance groove, an increase in a thickness of the electrode assembly caused by a connection of the first tab into the electrode assembly may be reduced, reducing a volume of the electrode assembly, and further improving an energy density of a battery.

Other configurations, other objectives, and other beneficial effects of the present application may be described in conjunction with accompanying drawings.

### BRIEF DESCRIPTION OF THE DRAWINGS

In order to more clearly illustrate technical solutions of embodiments of the present application, drawings that need to be used in descriptions of the embodiments are briefly described below, it is obvious that the drawings in the following descriptions are some of the present application, and for a person of ordinary skill in the art, other drawings may be obtained according to these drawings without creative work.

FIG. 1a is a cross-sectional view of an electrode assembly according to an embodiment of the present application.

FIG. 1b is a schematic diagram of an enlarged structure of the portion Ain FIG. 1a.

FIG. 1c is a schematic diagram of an enlarged structure of the portion B in FIG. 1a.

FIG. 1d is a cross-sectional view of another electrode assembly according to an embodiment of the present application.

FIG. 2a is a top view of an electrode plate according to an embodiment of the present application.

FIG. 2b is a cross-sectional view of another electrode plate according to an embodiment of the present application.

FIG. 2c is a cross-sectional view of a first electrode plate according to an embodiment of the present application.

FIG. 2d is a top view of a first electrode plate according to an embodiment of the present application.

FIG. 2e is a cross-sectional view of a second electrode plate according to an embodiment of the present application.

FIG. 2f is a top view of a second electrode plate according to an embodiment of the present application.

FIG. 3 is a top view of another electrode plate according to an embodiment of the present application.

FIG. 4 is a top view of another electrode plate according to an embodiment of the present application.

FIG. 5 is a top view of another electrode plate according to an embodiment of the present application.

FIG. 6 is a cross-sectional view of another electrode plate according to an embodiment of the present application.

FIG. 7 is a cross-sectional view of another electrode assembly according to an embodiment of the present application.

FIG. 8 is a cross-sectional view of another electrode assembly according to an embodiment of the present application.

FIG. 9 is a schematic diagram of an enlarged structure of the portion C in FIG. 8.

FIG. 10 is a top view of a welding area according to an embodiment of the present application.

FIG. 11 is a schematic structural diagram of a welding mask according to an embodiment of the present application.

FIG. 12 is a schematic structural diagram of another welding mask according to an embodiment of the present application.

FIG. 13 is a schematic structural diagram of another welding mask according to an embodiment of the present application.

FIG. 14 is a schematic structural diagram of another welding mask according to an embodiment of the present application.

FIG. 15 is a schematic diagram of an enlarged structure of a single welding mask in FIG. 13.

FIG. 16 is a schematic structural diagram of another welding mask according to an embodiment of the present application.

FIG. 17 is a schematic structural diagram of a linear welding mark according to an embodiment of the present application.

FIG. 18 is a schematic structural diagram of another linear welding mark according to an embodiment of the present application.

FIG. 19 is a schematic structural diagram of another linear welding mark according to an embodiment of the present application.

FIG. 20 is a schematic structural diagram of another linear welding mark according to an embodiment of the present application.

FIG. 21 is a schematic structural diagram of another linear welding mark according to an embodiment of the present application.

FIG. 22 is a cross-sectional view of another electrode plate according to an embodiment of the present application.

FIG. 23 is a top view of another electrode plate according to an embodiment of the present application.

FIG. 24 is a top view of another electrode plate according to an embodiment of the present application.

FIG. 25 is a top view of another electrode plate according to an embodiment of the present application.

FIG. 26 is a top view of another electrode plate according to an embodiment of the present application.

FIG. 27 is a top view of another electrode plate according to an embodiment of the present application.

### DETAILED DESCRIPTIONS OF THE EMBODIMENTS

In related technologies, an electrode assembly includes at least two electrode plates, two adjacent electrode plates have opposite polarities, and a separator is disposed between the two adjacent electrode plates to electrically isolate the two adjacent electrode plates. The electrode plate is connected to a tab, and the electrode plate is electrically connected to an external circuit structure through the tab. However, the tab has a certain thickness, and in a region where the tab is connected, a thickness of the electrode plate is increased due to arrangement of the tab, so that a thickness of the electrode assembly is increased, increasing a volume of the electrode assembly, and further reducing an energy density of a battery.

In view of the above technical problems, embodiments of the present application provide an electrode assembly and a battery. In the electrode assembly, a first groove is provided on a first electrode plate of two adjacent electrode plates, and a first current collector is connected to a first tab in the first groove; a second electrode plate of the two adjacent electrode plates is provided with a first avoidance groove, the first avoidance groove is disposed opposite to the first groove in a stacking direction of the electrode plates, and the first tab is completely covered by a projection of the first avoidance groove on the first electrode plate. Due to arrangement of the first avoidance groove, an increase in a thickness of the electrode assembly caused by a connection of the first tab into the electrode assembly may be reduced, reducing a volume of the electrode assembly, and further improving an energy density of a battery.

In order to make the objectives, technical solutions, and advantages of the embodiments of the present application clearer, the technical solutions in the embodiments of the present application are clearly and completely described below with reference to the accompanying drawings in the embodiments of the present application. Apparently, the described embodiments are a part of the embodiments of the present application, rather than all the embodiments. Based on the embodiments of the present application, all other embodiments obtained by a person of ordinary skill in the art without creative work fall within the protection scope of the present application.

The embodiments of the present application provide an electrode assembly (also referred to as a battery cell), and the electrode assembly may be applied to a battery. The battery cell refers to an electrochemical cell containing a positive electrode and a negative electrode and installed inside a battery. The battery cell is generally not directly used, and is installed inside a housing of a battery to form a battery for charging/discharging. Since the battery cell is a power storage portion in a battery, a quality of the battery is directly determined by a quality of the battery cell.

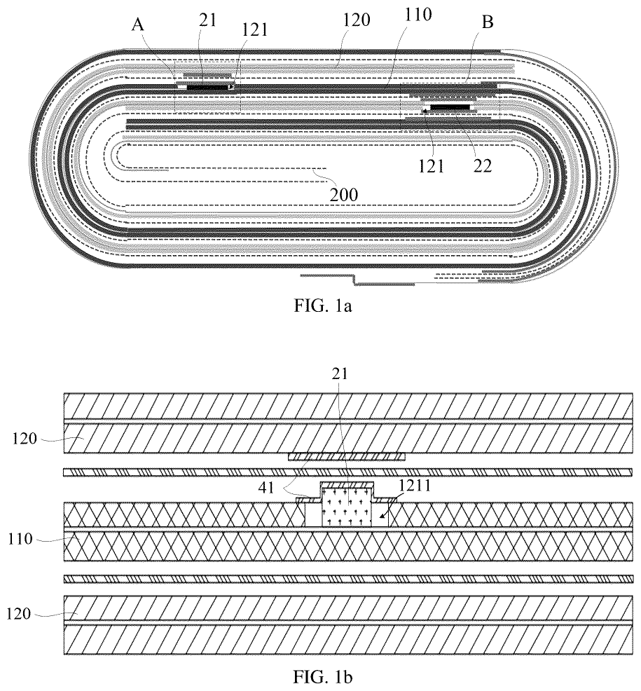

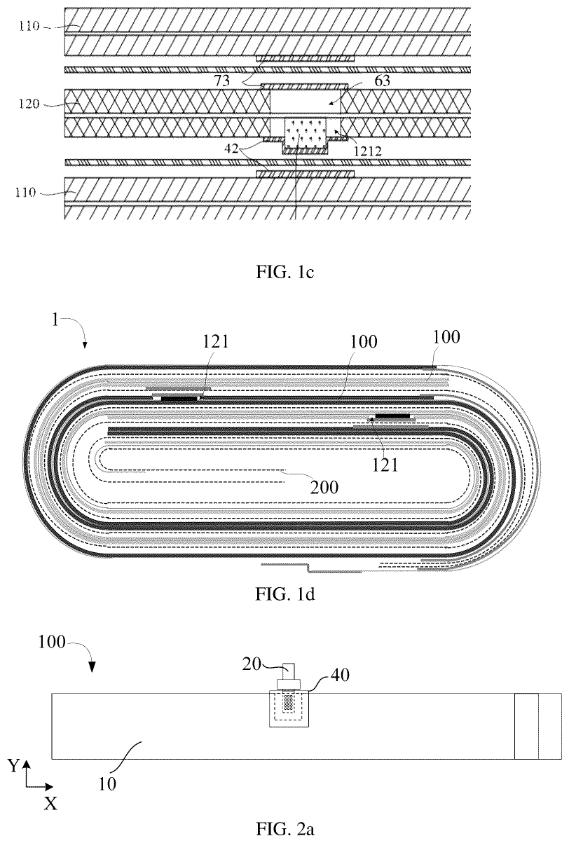

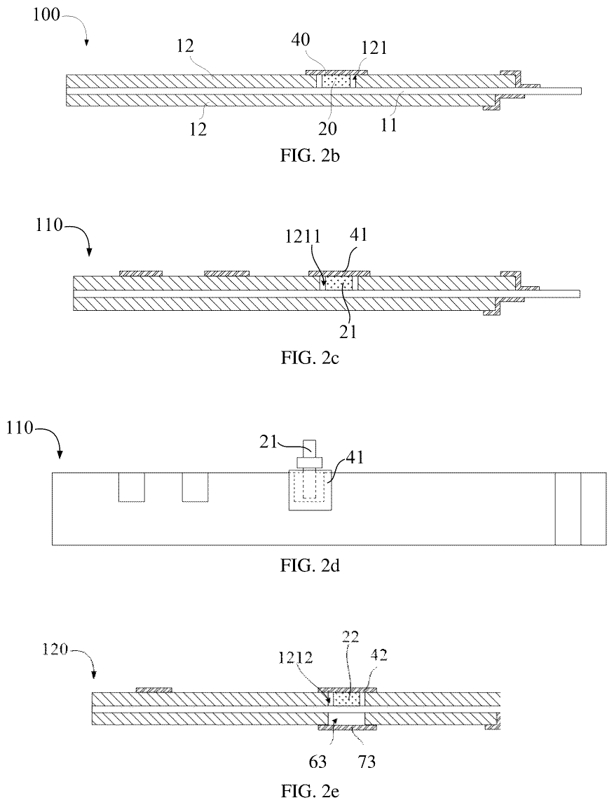

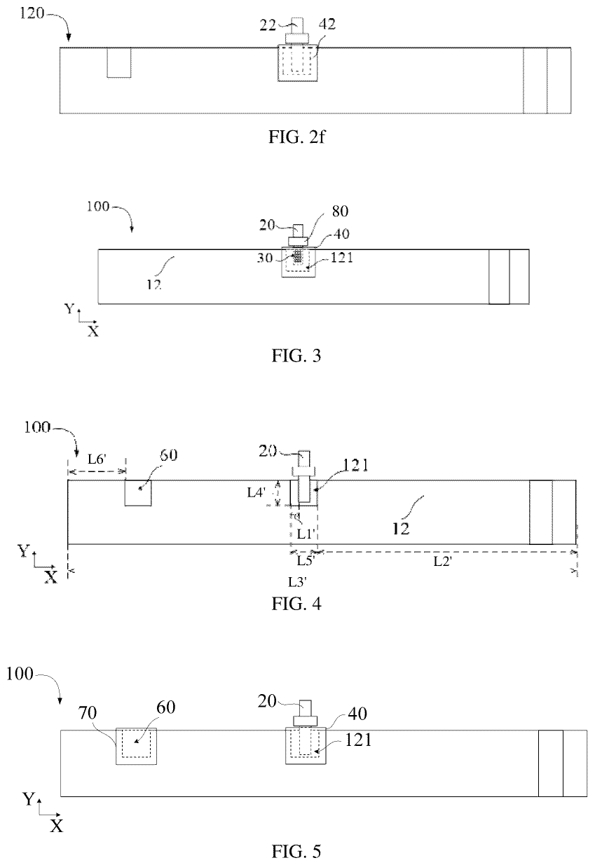

As shown in FIG. 1a, FIG. 2a and FIG. 7, an electrode assembly 1 includes at least two electrode plates 100 stacked on each other, two adjacent electrode plates 100 have opposite polarities, a positive electrode plate and a negative electrode plate of a battery are formed by two electrode plates 100 with opposite polarities, respectively, and the two electrode plates 100 with opposite polarities are electrically isolated through a separator 200, i.e., the separator 200 is disposed between every two adjacent electrode plates 100.

The at least two electrode plates 100 may include a first electrode plate 110 and a second electrode plate 120 adjacent to each other, and in order to avoid a short circuit between the first electrode plate 110 and the second electrode plate 120, the separator 200 is located between the first electrode plate 110 and the second electrode plate 120 for electrically insulating the first electrode plate 110 and the second electrode plate 120. The first electrode plate 110 is provided with a first tab 21, and the second electrode plate 120 is provided with a second tab 22.

For example, the first electrode plate 110 may be a positive electrode plate, the first tab 21 may be a positive tab, the second electrode plate 120 may be a negative plate, and the second tab 22 may be a negative tab. For another example, the first electrode plate 110 may be a negative electrode plate, the first tab 21 may be a negative tab, the second electrode plate 120 may be a positive electrode plate, and the second tab 22 may be a positive tab. It is not limited in the embodiments of the present application.

In some examples, the battery cell may be a winding battery cell. There are one first electrode plate 110 and one second electrode plate 120, and the first electrode plate 110, the separator 200 and the second electrode plate 120 which are sequentially stacked are wound around a winding center to form a winding structure. In other examples, the battery cell may be a laminated battery cell. There are a plurality of first electrode plates 110 and a plurality of second electrode plates 120, the plurality of first electrode plates 110 and the plurality of second electrode plates 120 are sequentially staggered and stacked in a same direction, and the separator 200 is disposed between each adjacent first electrode plate 110 and second electrode plate 120, so that the first electrode plate 110 and the second electrode plate 120 are electrically insulated. In the embodiments of the present application, a winding electrode assembly 1 is used as an example for detailed description.

It should be noted that, as shown in FIG. 2a, a width direction of the electrode plate 100 is a first direction of the electrode plate, i.e., a Y direction shown in FIG. 2a; a length direction of the electrode plate 100 is a second direction of the electrode plate, i.e., a X direction shown in FIG. 2a; and the first direction and the second direction may be perpendicular to each other. As shown in FIG. 1a, a thickness direction of the electrode plate 100 is a stacking direction of the electrode plates, i.e., a direction from top to bottom or a direction from bottom to top shown in FIG. 1a, the stacking direction of the electrode plates is perpendicular to both the first direction and the second direction, and the thickness direction of the electrode plate 100 may be consistent with a thickness direction of the tab 20, the electrode assembly 1 and the battery. For example, a length direction of the tab 20 may be the first direction Y, and a width direction of the tab 20 may be the second direction X. In the embodiments of the present application, a width direction and a length direction are merely for convenience of description and do not meant to limit any size. For example, a width may be greater than, less than or equal to a length.

In an embodiment of the present application, the electrode plate 100 may be the first electrode plate 110 in the above embodiments, or may be the second electrode plate 120 in the above embodiments. As shown in FIGS. 2a and 2f, the electrode plate 100 includes an electrode plate body 10, and the electrode plate body 10 and a tab 20 are electrically connected. A portion of the tab 20 and a portion of the electrode plate body 10 are stacked on each other, so that the tab 20 and the electrode plate body 10 are connected through a stacked position.

The electrode plate body 10 includes a current collector 11 and an active material layer 12. The electrode plate 100 may be a negative electrode plate or a positive electrode plate, and a polarity of the electrode plate 100 may be determined according to a specific selection of a material of the current collector 11 and each active material layer 12. For example, when the current collector 11 is an aluminum foil and the material of the active material layer 12 is a positive electrode active material such as a ternary material or lithium ferrous phosphate, the electrode plate 100 is a positive electrode plate, and the active material layer 12 on the positive electrode plate is a positive electrode active material layer. When the current collector 11 is a copper foil and the material of the active material layer 12 is a negative electrode active material such as graphite or silicon, the electrode plate 100 is a negative electrode plate, and the active material layer 12 on the negative electrode plate is a negative electrode active material layer.

The current collector 11 includes two surfaces disposed opposite to each other, and the active material layer 12 is disposed on the two surfaces, respectively. The two surfaces, disposed opposite to each other, of the current collector 11 refer to two opposite surfaces of the current collector 11 with largest areas, which are used for coating the active material layer 12. The active material layer 12 may be only coated on one surface of the current collector 11, or simultaneously coated on the two surfaces of the current collector 11 at the same time.

In an embodiment of the present application, as shown in FIG. 1d and FIG. 2b, in one electrode plate 100, a groove 121 is provided in the active material layer 12 on one surface of the current collector 11, and a portion of the one surface of the current collector 11 is exposed by the groove 121, i.e., a bottom wall of the groove 121 is the one surface of the current collector 11. In the groove 121, the current collector 11 is electrically connected to the tab 20.

The active material layer 12 corresponding to a position where the groove 121 is located on the current collector 11 may be removed by cleaning to expose the current collector 11, so that the groove 121 is formed. A thickness of the electrode assembly may be reduced due to the active material layer 12 at the groove 121 being removed. A cleaning method may be laser cleaning, mechanical cleaning, or foaming glue cleaning, which is not limited in the present application.

The groove 121 may be close to an edge of the electrode plate 100 in the width direction (i.e., the first direction Y), and a side, close to the edge, of the groove 121 is open. I.e., an outer side, close to the edge, of the groove 121 is not provided with the active material layer 12, and an outer side, away from the edge, of the groove 121 is provided with the active material layer 12.

When the groove 121 is disposed at an end of the electrode plate 100, a force applied to the groove 121 by two ends of the electrode plate 100 is uneven, so that the active material layer 12 at the groove 121 is easy to fall off. Therefore, in the embodiments, the groove 121 is located in a middle section of the current collector 11 in the length direction (i.e., the second direction X), so that the force applied to the groove 121 by the two ends of the electrode plate 100 is more consistent and balanced.

In addition, in related technologies, in order to weld a tab on a current collector, a region uncoated with active layer is provided at an end of the current collector, and active material layers on two surfaces of the end of the current collector are removed, so as to weld the tab on the region uncoated with active layer. However, the active material layers at the region uncoated with active layer of the current collector are completely removed, and along the width direction of the electrode plate (i.e., the first direction Y), a length of the region uncoated with active layer is equal to a length of the current collector, i.e., more active material layers are removed, resulting in lower activity of the electrode plate, and further reducing an energy density of a battery cell and a battery.

For the above technical problems, in the electrode plate 100 of the embodiments of the present application, along the first direction, a length of the groove 121 is less than a length of the current collector 11, i.e., only a portion of the active material layer 12 in the first direction is removed. The length of the groove 121 is set to be less than the length of the current collector 11 along the first direction, i.e., the length of the groove 121 is less than the length of region uncoated with active layer, so that the removed active material layer 12 can be reduced, improving an activity of the electrode plate 100, and further improving an energy density of a battery cell and a battery.

In an embodiment of the present application, one electrode plate 100 in the two adjacent electrode plates is the electrode plate 100 shown in FIG. 2b in the above embodiments, i.e., one electrode plate 100 in the two adjacent electrode plates is provided with the groove 121 in the above embodiments. As shown in FIG. 7, another electrode plate 100 in the two adjacent electrode plates is provided with a avoidance groove 60, a slot of the avoidance groove 60 is located on a surface, away from the current collector 11, of the active material layer 12, and a bottom wall of the avoidance groove 60 is a surface of the current collector 11.

The avoidance groove 60 and the groove 121 are disposed opposite to each other along a thickness direction of the electrode assembly 1 (i.e., the stacking direction of the electrode plates). FIG. 7 only shows that the avoidance groove 60 and the slot of the groove 121 are disposed facing each other, and in addition, the avoidance groove 60 and the slot of the groove 121 may also be disposed to depart from each other. In the following, a third avoidance groove 63 and a second groove 1212 may be taken as an example to describe the avoidance groove 60 and the slot of the groove 121 disposed to depart from each other, which is not described in detail herein.

The avoidance groove 60 may be close to an edge of the electrode plate 100 in the width direction, and a side, close to the edge, of the avoidance groove 60 is open. I.e., an outer side, close to the edge, of the avoidance groove 60 is not provided with the active material layer 12, and an outer side, away from the edge, of the avoidance groove 60 is provided with the active material layer 12.

The tab 20 located in the groove 121 is completely covered by a projection of the avoidance groove 60 on the electrode plate 100 having the groove 121. I.e., a size of a portion of the tab 20 located in the groove 121 is less than a size of the avoidance groove 60, disposal of the avoidance groove 60 can achieve a good avoidance effect on the tab 20, and reduce a thickness increase caused by the tab 20 to the electrode assembly 1, reducing a volume of the electrode assembly 1, and further improving an energy density of a battery.

Similarly, the active material layer 12 corresponding to a position where the avoidance groove 60 is located on the current collector 11 may be removed by cleaning, so as to expose the current collector 11, so that the avoidance groove 60 is formed. A thickness of the electrode assembly 1 at the avoidance groove 60 may be reduced due to the active material layer 12 at the avoidance groove 60 being removed. A cleaning method may be laser cleaning, mechanical cleaning, or foaming glue cleaning, which is not limited in the present application.

In the electrode plate provided with the avoidance groove 60, the avoidance groove 60 may be located in a middle section of the electrode plate 100 in the length direction, so that a force applied to the active material layer 12 at the avoidance groove 60 by two ends of the electrode plate 100 is consistent and balanced.

Taking the first electrode plate 110 and the second electrode plate 120 that are adjacent to each other as an example, a position of an avoidance groove and a groove in the electrode plate 100 in the present application is described.

In a possible implementation, as shown in FIG. 2c and FIG. 8, a first electrode plate 110 includes a first current collector and a first active material layer, the first current collector includes a first surface and a second surface disposed opposite to each other, the first surface and the second surface are covered by the first active material layer, the first active material layer on the first surface is provided with a first groove 1211, a slot of the first groove 1211 is located on a surface, away from the first current collector, of the first active material layer, i.e., the slot of the first groove 1211 is located on the surface, away from the first current collector, of the first active material layer on the first surface, a bottom wall of the first groove 1211 is the first surface, and in the first groove 1211, the first surface of the first current collector is electrically connected to a first tab 21. On the first current collector, a projection of the first groove 1211 is within a projection of the first active material layer on the second surface, and therefore, the first active material layer on the second surface directly opposite to the first groove 1211 is not removed and retained. I.e., the first active material layer on a back surface of the first groove 1211 is not removed, and therefore, an exposed area of the first current collector is relatively small, so that an activity of the first electrode plate 110 is relatively high.

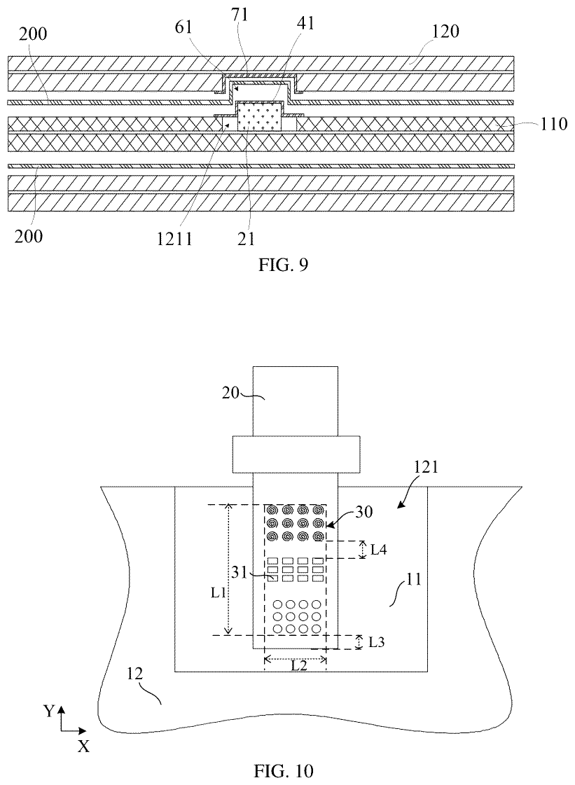

In a possible implementation, as shown in FIGS. 8 and 9, a second electrode plate 120 adjacent to the first electrode plate 110 includes a second current collector and a second active material layer, the second current collector includes a third surface and a fourth surface disposed opposite to each other, the third surface and the fourth surface are covered by the second active material layer, the second active material layer on the fourth surface is provided with a first avoidance groove 61, i.e., the first avoidance groove 61 is located in the second active material layer on a side, close to the first groove 1211, of the second electrode plate 120, and the first avoidance groove 61 and the first groove 1211 are disposed opposite to each other along the thickness direction of the electrode assembly 1. On the one hand, disposal of the first avoidance groove 61 may reduce a thickness of a portion of the electrode assembly 1, so as to ensure an energy density of a battery; and on the other hand, the first tab 21 located in the first groove 1211 is completely covered by a projection of the first avoidance groove 61 on the first electrode plate 110, forming a good avoidance effect on the first tab 21.

In a possible implementation, as shown in FIG. 8, in the second electrode plate 120, the second active material layer on the fourth surface of the second current collector is provided with a second groove 1212, the fourth surface of the second current collector is exposed by the second groove 1212, a slot of the second groove 1212 is located on a surface, away from the second current collector, of the second active material layer of the fourth surface, a bottom wall of the second groove 1212 is the fourth surface, and in the second groove 1212, the fourth surface of the second current collector is electrically connected to a second tab 22. On the second current collector, a projection of the second groove 1212 is within a projection of the second active material layer on the third surface, and therefore, the second active material layer on the third surface directly opposite to the second groove 1212 is not removed and retained. I.e., the second active material layer on a back surface of the second groove 1212 is not removed, and therefore, an exposed area of the second current collector is relatively small, so that an activity of the second electrode plate 120 is relatively high.

In a possible implementation, as shown in FIG. 8, in the first electrode plate 110, the first active material layer on the first surface of the first current collector is provided with a second avoidance groove 62, i.e., the second avoidance groove 62 is located in the first active material layer, close to the second groove 1212, of the first electrode plate 110, and the second avoidance groove 62 and the second groove 1212 are disposed opposite to each other along the thickness direction of the electrode assembly 1. Disposal of the second avoidance groove 62 may reduce a thickness of a portion of the electrode assembly 1, so as to ensure an energy density of a battery. On the one hand, disposal of the second avoidance groove 62 may reduce a thickness of a portion of the electrode assembly 1, so as to ensure an energy density of a battery; and on the other hand, the second tab 22 located in the second groove 1212 is completely covered by a projection of the second avoidance groove 62 on the second electrode plate 120, forming a better avoidance effect on the second tab 22.

In a possible implementation, as shown in FIGS. 1c and 2e, in the second electrode plate 120, the second active material layer on the third surface of the second current collector is provided with a third avoidance groove 63, a slot of the third avoidance groove 63 is located on a surface, away from the second current collector, the second active material layer on the third surface, a bottom wall of the third avoidance groove 63 is the third surface, and the third avoidance groove 63 and the second groove 1212 are disposed opposite to each other along a thickness direction of the second electrode plate 120. The second active material layer on the third surface directly opposite to the second groove 1212 is removed to form the third avoidance groove 63, reducing a thickness of the second electrode plate 120 at the third avoidance groove 63 and the second groove 1212, and further reducing an impact on a thickness of the second electrode plate 120 by the second tab 22.

It should be noted that arrangement related to a groove is suitable for the first groove and the second groove mentioned above, and arrangement related to an avoidance groove is suitable for the first avoidance groove, the second avoidance groove, and the third avoidance groove mentioned above.

In an embodiment of the present application, as shown in FIGS. 2a and 7, a surface, away from the current collector 11, of the tab 20 is covered with a protective layer 40, and disposal of the protective layer 40 may avoid a short circuit between adjacent positive and negative electrode plates in a battery caused by a film layer outside the electrode plate 100 being pierced by welding burrs formed during welding of the tab 20 to the current collector 11, avoiding an impact on a performance or safety of a battery. In addition, the protective layer 40 has a fixing effect on the tab 20, so that the tab 20 is further fixed on the electrode plate 100. The groove 121 may be completely covered by the protective layer 40, which may prevent burrs at the groove 121 from affecting safety of a battery.

For example, in the first electrode plate 110, a first protective layer 41 is provided on a side, away from the first current collector, of the first tab 21, i.e., at least one side of the separator 200 adjacent to the first groove 1211 is provided with the first protective layer 41, providing protection for the separator 200 adjacent to the first tab 21. For example, the first protective layer 41 may be located on a surface, away from the first current collector, of the first tab 21, and for another example, the first protective layer 41 may be located on a surface, facing the first tab 21, of the separator 200 adjacent to the first tab 21. On the first current collector, a projection of the first groove 1211 is within a projection of the first protective layer 41, i.e., the first groove 1211 is completely covered by the first protective layer 41. Disposal of the first protective layer 41 may isolate burrs on the first groove 1211 and the first tab 21, avoiding a short circuit between the first electrode plate 110 and the second electrode plate 120.

For example, in the second electrode plate 120, a second protective layer 42 is provided on a side, away from the second current collector, of the second tab 22, i.e., at least one side of the separator 200 adjacent to the second tab 22 is provided with the second protective layer 42, providing protection for the separator 200 adjacent to the second tab 22. For example, the second protective layer 42 may be located on a surface, away from the second current collector, of the second tab 22, and for another example, the second protective layer 42 may be located on a surface, facing the second tab 22, of the separator 200 adjacent to the second tab 22. On the second current collector, a projection of the second groove 1212 is within a projection of the second protective layer 42, i.e., the second groove 1212 is completely covered by the second protective layer 42. Disposal of the second protective layer 42 may isolate burrs on the second groove 1212 and the second tab 22, avoiding a short circuit between the first electrode plate 110 and the second electrode plate 120.

A thickness of the protective layer 40 may be in a range of 0.001 mm to 0.1 mm along the stacking direction of the electrode plates. For example, the thickness of the protective layer 40 may be 0.001 mm, 0.005 mm, 0.01 mm, 0.012 mm, 0.05 mm, or 0.1 mm, and the like. When the thickness of the protective layer 40 is less than the thickness with this range, the protective layer 40 is relatively thin, which may result in a poor protection effect of the protective layer 40. When the thickness of the protective layer 40 is greater than the thickness with this range, the protective layer 40 is relatively thick, which may result in more internal space of a battery being occupied.

In an embodiment of the present application, as shown in FIG. 4, along the second direction X, the tab 20 located in the groove 121 and the active material layer 12 located at the groove 121 have a distance L1′, i.e., there is a gap between an edge of the tab 20 and an edge of a slot of the groove 121, which avoids affecting the active material layer 12 at the groove 121 during welding of the tab 20 to the current collector.

The distance L1′ may range from 0.001 mm to 5 mm, for example, the distance L1′ may be 0.001 mm, 0.01 mm, 0.05 mm, 0.1 mm, 0.5 mm, 1 mm, 3 mm, or 5 mm, and the like, which not only avoids affecting the active material layer 12 at the groove 121 during welding of the tab 20 caused by the distance L1′ being too small, but also avoids a situation that a large amount of active material layers 12 need to be cleaned caused by the distance L1′ being too large, avoiding an impact on an energy density of a battery.

In an embodiment of the present application, a thickness of the current collector 11 may be in a range of 0.001 mm to 0.02 mm along the stacking direction of the electrode plates. For example, the thickness of the current collector 11 may be 0.001 mm, 0.003 mm, 0.006 mm, 0.01 mm, 0.013 mm, 0.016 mm, or 0.02 mm, and the like, which is not limited in the present application.

In an embodiment of the present application, the groove 121 is located in a middle section of the current collector 11 in a length direction of the current collector 11 (i.e., the second direction X), so that a force applied to the groove 121 by two ends of the electrode plate 100 is more consistent and balanced. As shown in FIG. 4, along the second direction X, a distance between the groove 121 and an end of the current collector 11 in the length direction of the current collector 11 is L2′, a length of the current collector 11 is L3′, and a ratio L2′/L3′ may be in a range of ⅓ to ⅔, for example, the ratio L2′/L3′ may be ⅓, 2/4, ⅗, or ⅔, and the like, avoiding an uneven force applied to the groove 121 by the two ends of the electrode plate 100 caused by the range of L2′/L3′ being too small or too large.

In an embodiment of the present application, along the stacking direction of the electrode plates, a depth of the groove 121 is in a range of 0.01 mm to 0.2 mm, for example, the depth of the groove 121 may be 0.01 mm, 0.03 mm, 0.04 mm, 0.05 mm, 0.07 mm, 0.1 mm or 0.2 mm, and the like, which not only avoids a relatively low energy density of a battery caused by the active material layer 12 being too thin, but also avoids a situation that the active material layer 12 close to a surface of the current collector 11 cannot be utilized caused by the active material layer 12 being too thick, avoiding a relatively low utilization rate of the active material in the active material layer 12.

In an embodiment of the present application, as shown in FIG. 4, along the first direction Y, a length of the groove 121 is L4′, and the length L4′ may be in a range of 1 mm to 40 mm, for example, the length L4′ may be 1 mm, 2 mm, 5 mm, 10 mm, 15 mm, 20 mm, 30 mm, or 40 mm, and the like, which not only avoids a relatively small connectable area between the tab 20 and the current collector 11 caused by the length L4′ being too small, but also avoids a situation that a large amount of active material layers 12 need to be cleaned caused by the length L4′ being too large, avoiding a significant impact on an energy density of a battery.

In an embodiment of the present application, as shown in FIG. 4, along the second direction X, a length of the groove 121 is L5′, and the length L5′ may be in a range of 1 mm to 30 mm, for example, the length L5′ may be 1 mm, 2 mm, 5 mm, 10 mm, 15 mm, 20 mm, 25 mm, or 30 mm, and the like. A design principle of the length L5′ of the groove 121 in the second direction X is similar to that of the length L4′ of the groove 121 in the first direction Y, and details are not described again.

In an embodiment of the present application, a thickness of the tab 20 may be in a range of 0.01 mm to 1 mm along the stacking direction of the electrode plates, for example, the thickness of the tab 20 may be 0.01 mm, 0.03 mm, 0.05 mm, 0.1 mm, 0.3 mm, 0.5 mm, 0.7 mm, or 1 mm, and the like, which not only avoids a relatively high resistance of the tab 20 caused by the tab 20 being too thin, avoiding a poor over-current capability of the tab 20, but also avoids occupying too much internal space of a battery caused by the tab 20 being too thick.

In an embodiment of the present application, a length of the tab 20 may be in a range of 5 mm to 200 mm along the first direction Y, for example, the length of the tab 20 is 5 mm, 10 mm, 20 mm, 25 mm, 50 mm, 75 mm, 100 mm, 150 mm, or 200 mm, and the like, which not only avoids a relatively small connectable area between the tab 20 and the current collector 11 caused by the tab 20 being too short, avoiding a relatively low connection strength, but also avoids occupying too much internal space of a battery caused by the tab 20 being too long.

In an embodiment of the present application, a length of the tab 20 may be in a range of 1 mm to 20 mm along the second direction X, for example, the length of the tab 20 is 1 mm, 5 mm, 6 mm, 10 mm, 15 mm or 20 mm, and the like, which not only avoids a relatively small connectable area between the tab 20 and the current collector 11 caused by the tab 20 being too narrow, avoiding a relatively low connection strength, but also avoids occupying too much internal space of a battery caused by the tab 20 being too wide.

In an embodiment of the present application, as shown in FIG. 3, the electrode plate 100 may further be provided with an auxiliary adhesive layer 80, and the tab 20 is inserted into the auxiliary adhesive layer 80. After the electrode assembly 1 is formed by the electrode plate 100, an external of the electrode assembly 1 may be wrapped in a plastic shell to protect the electrode assembly 1. The auxiliary adhesive layer 80 may be used for sealing (adopting hot-melt sealing) a gap between the tab 20 and the plastic shell.

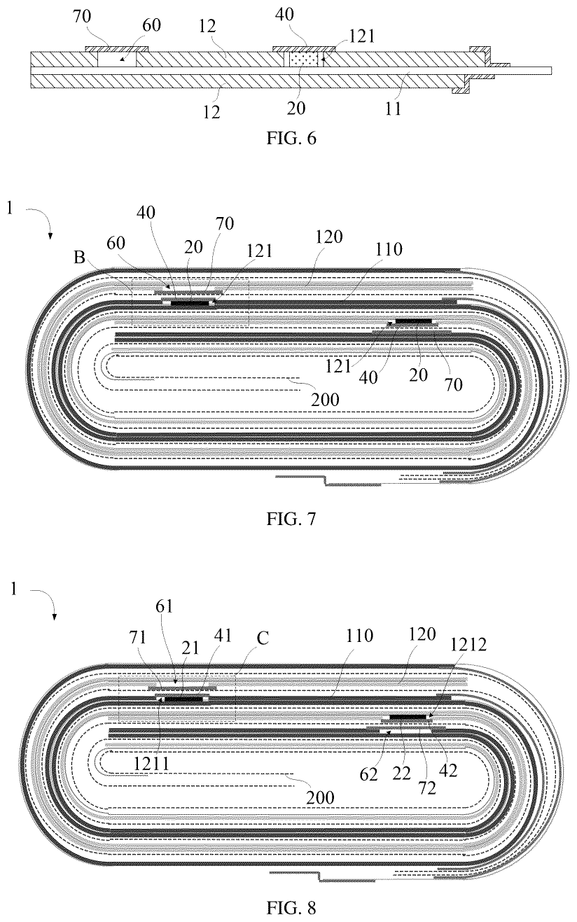

In an embodiment of the present application, as shown in FIGS. 4 to 6, along the first direction Y, a distance between the avoidance groove 60 and an end of the electrode plate 100 in the length direction of the electrode plate 100 is L6′, a length of the electrode plate 100 is L3′, and a ratio L6′/L3′ may be in a range of ¼ to ¾, for example, the ratio L6′/L3′ may be ¼, ⅖, ½, ⅗, ¾, and the like. When the ratio L6′/L3′ is in the ratio with this range, a force applied to the avoidance groove 60 by two ends of the electrode plate 100 is relatively uniform. In addition, as shown by the dashed box B in FIG. 7, when the ratio L6′/L3′ is within the ratio with this range, the groove 121 and the avoidance groove 60 in the dashed box B are relatively easy to meet requirements for disposing opposite to each other.

In an embodiment of the present application, along the stacking direction of the electrode plates, a depth of the avoidance groove 60 is in a range of 0.01 mm to 0.2 mm, for example, the depth of the avoidance groove 60 may be 0.01 mm, 0.03 mm, 0.04 mm, 0.05 mm, 0.07 mm, 0.1 mm or 0.2 mm, and the like. A design principle of the depth of the avoidance groove 60 is similar to that of the depth of the groove 121, and details are not described again.

In an embodiment of the present application, along the first direction Y, as shown in FIG. 4 and FIG. 5, a length of the avoidance groove 60 is in a range of 1 mm to 40 mm, for example, the length of the avoidance groove 60 may be 1 mm, 2 mm, 5 mm, 10 mm, 15 mm, 20 mm, 30 mm, or 40 mm, and the like, which not only avoids a situation that the avoidance groove 60 cannot well avoid the tab 20 caused by the length of the avoidance groove 60 being too small, but also avoids a relatively low activity of the electrode plate 100 caused by the length of the avoidance groove 60 being too long.

In an embodiment of the present application, along the second direction X, a length of the avoidance groove 60 is in a range of 1 mm to 30 mm, for example, the length of the avoidance groove 60 may be 1 mm, 2 mm, 5 mm, 10 mm, 15 mm, 25 mm, or 30 mm, and the like. A design principle of the length of the avoidance groove 60 in the second direction X is similar to that of the avoidance groove 60 in the first direction Y, and details are not described again.

In an embodiment of the present application, along the first direction Y, a ratio of a length of the avoidance groove 60 to a length of the groove 121 is in a range of 0.8 to 1.2, for example, the ratio may be 0.8, 0.9, 1, 1.1, 1.2, and the like, which not only avoids a situation that an impact on a thickness of the electrode plate 100 cannot be well reduced by the tab 20 caused by a size of the avoidance groove 60 being too small, but also avoids a situation that a large amount of active material layers 12 need to be removed caused by the size of the avoidance groove 60 being too large, avoiding a significant impact on an energy density of a battery.

In an embodiment of the present application, along the second direction X, a ratio of a length of the avoidance groove 60 to a length of the groove 121 is in a range of 0.8 to 1.2, for example, the ratio may be 0.8, 0.9, 1, 1.1, 1.2, and the like. A design principle of the range of the ratio of the length of the avoidance groove 60 to the length of the groove 121 along the second direction X is similar to that of the length of the avoidance groove 60 to the length of the groove 121 along the first direction Y, and details are not described again.

In an embodiment of the present application, as shown in FIG. 7, a protective layer 40 is disposed between the separator 200 adjacent to the tab 20 and the tab 20, and the groove 121 is completely covered by the protective layer 40, so as to avoid an impact on the separator 200 adjacent to the tab 20 by the groove 121. For example, the protective layer 40 is disposed on a surface, facing the separator 200 adjacent to the tab 20, of the tab 20, and for another example, the protective layer 40 is disposed on a surface, facing the tab 20, of the separator 200 adjacent to the tab 20.

In an embodiment of the present application, as shown in FIG. 7, an isolation layer 70 is provided between the separator 200 adjacent to the avoidance groove 60 and the avoidance groove 60, and the avoidance groove 60 is completely covered by the isolation layer 70, so as to avoid an impact on the separator 200 adjacent to the avoidance groove 60 by the avoidance groove 60. For example, the isolation layer 70 is disposed on a surface, facing the separator 200 adjacent to the avoidance groove 60, of the avoidance groove 60, and for another example, the isolation layer 70 is disposed on a surface, facing the avoidance groove 60, of the separator 200 adjacent to the avoidance groove 60.

For example, a first isolation layer 71 is disposed between the separator 200 adjacent to the first avoidance groove 61 and the first avoidance groove 61, so as to protect the separator 200 adjacent to the first avoidance groove 61. For example, the first isolation layer 71 may be located on a surface, facing the first groove 1211, of the first avoidance groove 61, and for another example, the first isolation layer 71 may be located on a surface, close to the first avoidance groove 61, of the separator 200 adjacent to the first avoidance groove 61. The first avoidance groove 61 is completely covered by the first isolation layer 71.

For example, a second isolation layer 72 is disposed between the separator 200 adjacent to the second avoidance groove 62 and the second avoidance groove 62, so as to protect the separator 200 adjacent to the second avoidance groove 62. For example, the second isolation layer 72 may be located on a surface, facing the second groove 1212, of the second avoidance groove 62, and for another example, the second isolation layer 72 may be located on a surface, close to the second avoidance groove 62, of the separator 200 adjacent to the second avoidance groove 62. The second avoidance groove 62 is completely covered by the second isolation layer 72.

For example, at least one side of the separator 200 adjacent to the third avoidance groove 63 is provided with a third isolation layer 73, and on the second current collector, a projection of the third avoidance groove 63 is within a projection of the third isolation layer 73, so that burrs on the third avoidance groove 63 may be isolated, avoiding a short circuit between the first electrode plate 110 and the second electrode plate 120.

In an embodiment of the present application, along the stacking direction of the electrode plates, a thickness of the isolation layer 70 may be in a range of 0.001 mm to 0.1 mm, for example, the thickness of the isolation layer 70 may be 0.001 mm, 0.005 mm, 0.01 mm, 0.012 mm, 0.05 mm, or 0.1 mm, and the like. A design principle of the thickness of the isolation layer 70 is similar to that of the protection layer 40, and details are not described herein again.

In an embodiment of the present application, as shown in the dashed box B in FIG. 7, when a thickness of the tab 20 in the groove 121 is equal to a depth of the groove 121, a portion of the separator 200, a portion of the protection layer 40, and a portion of the isolation layer 70 between the avoidance groove 60 and the groove 121 that are disposed opposite to each other are all entered into the avoidance groove 60 under an extrusion of the tab 20, avoiding an increase in the thickness of the electrode assembly 1 caused by arrangement of the tab 20, and further ensuring an energy density of a battery.

In an embodiment of the present application, as shown in the dashed box B in FIG. 7, when a thickness of the tab 20 in the groove 121 is greater than a depth of the groove 121, a portion of the separator 200, a portion of the protection layer 40, and a portion of the isolation layer 70 between the avoidance groove 60 and the groove 121 that are disposed opposite to each other are all entered into the avoidance groove 60 under an extrusion of the tab 20, and in addition, a portion of the tab 20 protrudes from the groove 121, which is also entered into the avoidance groove 60, avoiding an increase in the thickness of the electrode assembly 1 caused by arrangement of the tab 20. In addition, due to a presence of the avoidance groove 60, it is possible to set the tab 20 relatively thick, reducing a resistance of the tab 20, and further improving an over-current capability of the tab 20.

In an embodiment of the present application, as shown in FIG. 3 and FIG. 10, a welding area 30 is formed at a joint of the tab 20 and the current collector 11, the welding area 30 may have a plurality of welding marks 31, and the plurality of welding marks 31 are disposed at intervals, i.e., each welding mark is independent. Due to a relatively small input energy required to form a single welding mark, an impact on the active material layer 12 near the welding area 30 may be reduced.

For example, the tab 20 and the current collector 11 may be connected in a laser welding manner, and the laser is irradiated from a side, away from the current collector 11, of the tab 20, so as to weld the tab 20 and the current collector 11.

Arrangement of the welding mask 31 in the electrode plate 100 may be described below.

In a possible implementation, in the electrode plate 100 provided with the groove 121, the current collector 11 is welded to the tab 20, so as to form the welding mask 31, and at least a portion of the welding mask 31 is located on a surface, away from the current collector 11, of the tab 20, and protrudes toward a direction away from the current collector 11, so as to form a first protrusion.

In a possible implementation, in the electrode plate 100 provided with the groove 121, along a thickness direction of the current collector 11 (i.e., the stacking direction of the electrode plates), the welding mark 31 penetrates through the tab 20, and the welding mark 31 is located in a partial region, close to the tab 20, of the current collector 11. The welding mark 31 is formed on a side, away from the current collector 11, of the tab 20, and no welding mark 31 is formed on a side, away from the tab 20, of the current collector 11, i.e., a surface, away from the tab 20, of the current collector 11 is a plane, so that an impact on the active material layer 12 at the side, away from the tab 20, of the current collector 11 by the welding mark 31 is relatively small.

In a possible implementation, in the electrode plate 100 provided with the groove 121, along the thickness direction of the current collector 11 (i.e., the stacking direction of the electrode plates), the welding mark penetrates through the tab 20 and the current collector 11, and therefore, the welding mark 31 can all be observed on a surface, away from the current collector 11, of the tab 20 and on a surface, away from the tab 20, of the current collector 11. The welding mark 31 located on a side, away from the tab 20, of the current collector 11 is covered by the active material layer 12, so that an impact on the separator 200 located on the side, away from the tab 20, of the current collector 11 by the welding mark 31 can be reduced. The welding mark 31 located on the side, away from the tab 20, of the current collector 11 protrudes toward the side away from the tab 20, so as to form a second protrusion.

In a possible implementation, in the electrode plate 100 provided with the groove 121, in one welding mark 31, a portion of the welding mark 31 penetrates through the tab 20 and the current collector 11, and other portion of the welding mark 31 penetrates through the tab 20, and the welding mark 31 is further located in a partial region, close to the tab 20, of the current collector 11 along the thickness direction of the current collector 11 (i.e., the stacking direction of the electrode plates). For example, the welding mark 31 includes an outer edge portion and a middle portion, and the outer edge portion is annularly disposed on an outer side of the middle portion. Along the thickness direction of the current collector 11 (i.e., the stacking direction of the electrode plates), the outer edge portion penetrates through the tab 20 and the current collector 11, the outer edge portion located on the side, away from the tab 20, of the current collector 11 protrudes toward the side away from the tab 20, so as to form the second protrusion, and therefore, the outer edge portion of the welding mark 31 can be observed on the surface, away from the tab 20, of the current collector 11. The outer edge portion (i.e., the second protrusion) located on the side, away from the tab 20, of the current collector 11 is covered by the active material layer 12, so that an impact on the separator 200 located on the side, away from the tab 20, of the current collector 11 by the outer edge portion can be reduced. Along the thickness direction of the current collector 11 (i.e., the stacking direction of the electrode plates), the middle portion penetrates through the tab 20, the middle portion is located on a partial region, close to the tab 20, of the current collector 11, and therefore, the middle portion of the welding mark 31 cannot be observed on the surface, away from the tab 20, of the current collector 11.

In an embodiment of the present application, as shown in FIG. 10, at least some of the plurality of welding marks 31 have different shapes, and the plurality of welding marks 31 includes at least two different shapes of welding marks 31. Different shapes of welding marks 31 have different welding strength, meeting different requirements for different electrode plates 100 on the welding strength, and further making the electrode plate 100 and a battery more diverse.

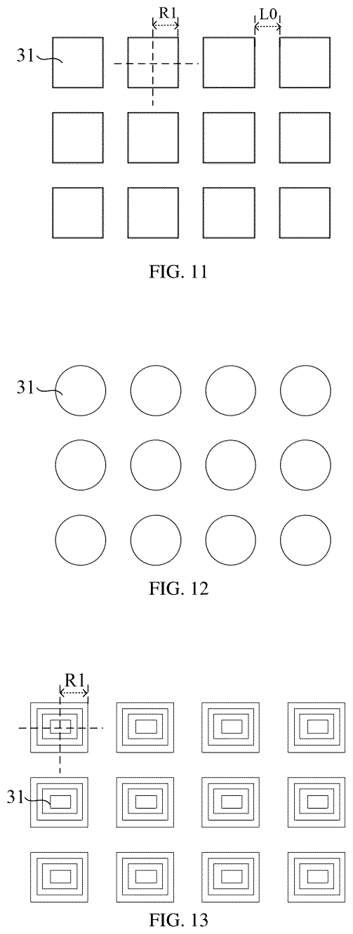

In an embodiment of the present application, as shown in FIG. 11, a distance between any two adjacent welding marks 31 is L0, and the distance L0 between the two adjacent welding marks 31 may be less than or equal to 5 mm, for example, the distance L0 between the two adjacent welding marks 31 may be 0.5 mm, 1 mm, 2 mm, 3 mm, 4 mm, or 5 mm, and the like, which may avoid dispersion of the welding marks 31 in the welding area 30 caused by the distance L0 being too large, so as to avoid a relatively low overall welding strength of the welding area 30 and a relatively low connection strength between the tab 20 and the electrode plate body 10.

In an embodiment of the present application, along the stacking direction of the electrode plates, a protrusion height (i.e., a protrusion height of the first protrusion) of the welding mark 31 located on the side, away from the current collector 11, of the tab 20 is less than or equal to 0.1 mm, for example, the protrusion height of the first protrusion may be 0.01 mm, 0.03 mm, 0.05 mm, 0.07 mm, 0.09 mm or 0.1 mm, and the like, which may avoid an impact on other film layers adjacent to the first protrusion (i.e., it is easy to pierce a separator adjacent to the first protrusion in a battery) caused by of the height of the first protrusion being too large, avoiding a short circuit between positive and negative electrodes of a battery.

In an embodiment of the present application, as shown in FIG. 10, along the first direction Y, a length of the welding area 30 is L1, and the length of the welding area 30 L1 is less than or equal to 40 mm, for example, the length of the welding area 30 L1 may be 10 mm, 20 mm, 30 mm or 40 mm, and the like, which may avoid a relatively large heat generated during formation of the welding area 30 caused by the length of the welding area 30 being too large, avoiding an impact on the active material layer 12 on the current collector 11.

In an embodiment of the present application, as shown in FIG. 10, along the second direction X, a length of the welding area 30 is L2, and the length L2 of the welding area 30 is less than or equal to 30 mm, for example, the length L2 of the welding area 30 may be 10 mm, 20 mm or 30 mm, and the like. A design principle of the length L2 of the welding area 30 along the second direction X is similar to that of the length L1 of the welding area 30 along the first direction Y, and details are not described herein again.

In an embodiment of the present application, as shown in FIG. 10, along the first direction Y, a distance between an edge of an end of the tab 20 in a groove 121 and an edge of the welding area 30 is L3, the distance L3 may be less than or equal to 5 mm, for example, the distance L3 may be 1 mm, 2 mm, 3 mm, 4 mm, or 5 mm, and the like, which may avoid a relatively small area of the welding area 30 caused by the distance L3 being too large, avoiding a relatively low overall welding strength of the welding area 30 and a relatively low connection strength between the tab 20 and the current collector 11.

In an embodiment of the present application, as shown in FIG. 10, the plurality of welding marks 31 are disposed in at least one matrix. Matrix arrangement is more attractive and tidy, and the plurality of welding marks 31 are well distributed, so that a welding evenness of the welding area 30 is better. For example, the number of matrices formed by the plurality of welding marks 31 may be one, two, three, or four, and the like, which is not limited in the present application.

In some examples, the number of matrices may be one, shapes of the plurality of welding marks 31 in the one matrix include at least two types, for example, the number of shapes of the plurality of welding marks 31 in the one matrix is two, three, four or five, and the like, which is not limited in the present application. Due to a fact that the welding marks 31 in different shapes have different welding strength, different requirements for different electrode plates 100 on the welding strength may be met, making the electrode plate 100 and a battery more diverse.

In some other examples, the number of matrices may be greater than or equal to 2. At least two matrices may also be disposed in an array, so that arrangement of the at least two matrices is tidy and attractive, and the at least two matrices in the welding area 30 are well distributed, so as to further improve a welding evenness of the welding area 30. In addition, there is a gap between any two matrices, and an area of each matrix is relatively small, and therefore, an input heat during formation of the matrix is relatively low, so that the active material layer 12 near the welding area 30 is less impacted.

For example, the at least two matrices may be disposed in one column along the first direction Y, or the at least two matrices may be disposed in one row along the second direction X, or the at least two matrices may be disposed in rows and columns along the first direction Y and the second direction X. Certainly, the at least two matrices may also be disposed in an array in other directions, which is not limited in the present application.

The following may be described below by disposing at least two matrices along the first direction Y.

The number of welding marks 31 in each matrix may be same or may be different. For example, the number of welding marks 31 in one matrix may be 6, 9, 12, 16, or 20, and the like, and the number of welding marks 31 is not limited in a single matrix in the present application.

In some examples, the shapes of the plurality of welding marks 31 in a same matrix may be same, so that a relatively low welding difficulty is achieved, and the plurality of welding marks 31 may be formed without changing welding parameters.

In some other examples, the plurality of welding marks 31 in a same matrix include at least two different shapes of welding marks 31. Since the welding marks 31 with different shapes have different welding strength, different requirements for different electrode plates 100 on the welding strength may be met, so that the electrode plate 100 and a battery are more diversified. For example, in a same matrix, the number of shapes of the plurality of welding marks 31 may be two, three, four, or five, and the like, which is not limited in the present application. The more the shape types of the welding marks 31 are, the more diverse the welding strength of the welding marks 31 are, which can better meet different welding strength requirements, and thus meet requirements for different products.

As shown in FIG. 10, along the first direction Y, a distance between any two adjacent matrices is L4, a ratio of the distance L4 to an extension length L1 of the welding area 30 along the first direction Y is in a range of 1% to 25% (i.e., L4/L1), for example, L4/L1 may be 1%, 5%, 10%, 15%, 20% or 25%, and the like, which not only avoids the distance between two adjacent matrices being too close caused by a value of L4/L1 being too small, avoiding easy interaction between the two adjacent matrices, but also avoids the distance between the two matrices being too far caused by the value of L4/L1 being too large, avoiding a relatively few matrices in the welding area 30, and further avoiding a relatively low welding strength.

For example, the distance L4 between the two adjacent matrices may be less than or equal to 10 mm, for example, the distance L4 between the two adjacent matrices may be 1 mm, 3 mm, 5 mm, 7 mm, 9 mm, or 10 mm, and the like. A design principle of the distance L4 between any two adjacent matrices is similar to that of the value of L4/L1, and details are not described herein again.

A shape of the welding mark 31 may be described in detail below.

As shown in FIG. 10 to FIG. 21, a shape of the welding mark 31 may be spiral, concentric circle, concentric squares, square, circular, straight, wavy, zigzag, regular shape, or other irregular shapes, and the like, and the shape of the welding mark 31 is not limited in the present application.

As shown in FIGS. 11 and 12, the shape of the welding mark 31 may be circular or square. Certainly, the shape of the welding mark 31 may also be triangular, elliptical, polygonal, or other shapes, and the like, and the shape of the welding mark 31 is not limited in the present application.

A surface of the welding mark 31 is uneven, the surface may include a protruding portion and a recessed portion, and the protruding portion and the recessed portion are formed by solidifying after the tab 20 and the current collector 11 are melted. Disposal of the protruding portion and the recessed portion increases a contact area between the tab 20 and the current collector 11, so that a relatively high welding strength is achieved.

As shown in FIG. 13, when the shape of the welding mark 31 is square, a distance from a center of the welding mark 31 to an edge of the welding mark 31 is R1, the distance R1 ranges from 0.005 mm to 3 mm, for example, the distance R1 may be 0.01, 0.25 mm, 1 mm, 2 mm, or 3 mm, and the like, which not only avoids a relatively low welding strength caused by the welding mark 31 being too small, but also avoids a relatively high input energy required to form one welding mark 31 caused by the welding mark 31 being too large, avoiding an impact on the active material layer 12 near the welding area 30.

It should be noted that FIG. 13 is merely an example, regardless of the shape of the welding mark 31, in each welding mark 31, the distance between the center of the welding mark 31 and an outer edge of the welding mark 31 may range from 0.05 mm to 2.5 mm, for example, the distance may be 0.05 mm, 0.25 mm, 0.5 mm, 1 mm, 1.5 mm, or 2.5 mm, and the like, which not only avoids a relatively small contact area between the tab 20 at the welding mark 31 and the current collector 11 caused by the welding mark 31 being too small, avoiding an invalid welding tension and a relatively low welding strength, but also avoids a relatively high input energy required to form one welding mark 31, avoiding an impact on the active material layer 12 near the welding area 30.

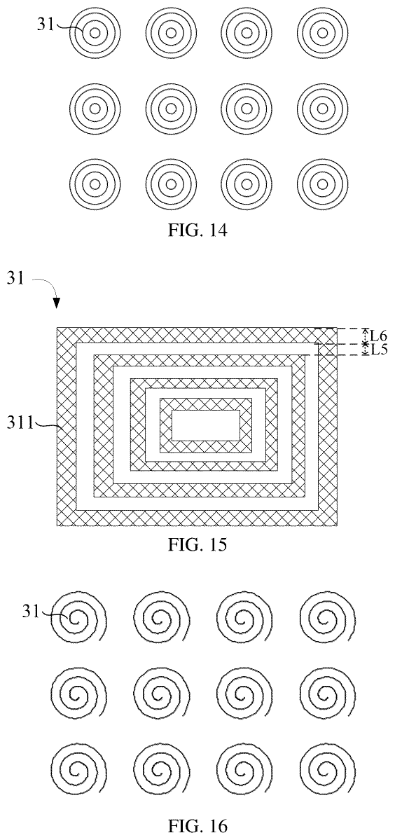

As shown in FIG. 13 to FIG. 15, the shape of the welding mark 31 may be formed by a plurality of annular lines 311 sequentially sleeved from inside to outside and disposed at intervals. The number of annular lines 311 may be 1, 2, 3, 4, or 5, and the like, and the number of annular lines 311 is not limited in the present application. For example, when the shape of the welding mark 31 is the concentric squares shown in FIG. 13 and FIG. 15, the shape of the annular line 311 is a square ring, and for another example, when the shape of the welding mark 31 is the concentric circle shown in FIG. 14, the annular line 311 is a circular ring. The shape of the annular line 311 may also be a triangular ring, a trapezoidal ring, an elliptical ring, a polygonal ring, or other shapes, and the like, and the shape of the annular line 311 is not limited in the present application.

As shown in FIG. 15, the annular line 311 may form a protruding portion of the welding mask 31, and a portion between two adjacent annular lines 311 is a planar structure of the current collector 11. A distance between the two adjacent annular lines 311 is L5, the distance L5 may be less than or equal to 3 mm, for example, the distance L5 may be 1 mm, 2 mm, or 3 mm, and the like, which may avoid a relatively small effective connection area between the tab 20 and the current collector 11 caused by the distance L5 being too large, avoiding a relatively low welding strength. In one annular line 311, a width of the annular line 311 (i.e., a ring welding mark) is L6, the width L6 is in a range of 0.01 mm to 0.02 mm, for example, the width L6 may be 0.01 mm, 0.05 mm, 0.1 mm, 0.15 mm, or 0.2 mm and the like, which not only avoids a relatively low connection strength of the annular line 311 caused by the annular line 311 being too narrow, preventing the welding mark 31 from easily failing, but also avoids a relatively high input energy required to form the annular line 311 caused by the annular line 311 being too wide, avoiding an impact on the active material layer 12 near the welding area 30.

As shown in FIG. 16, the shape of the welding mark 31 may be spiral, and dimension parameters of the welding mark 31 are similar to those of the above welding mark and details are not described again.

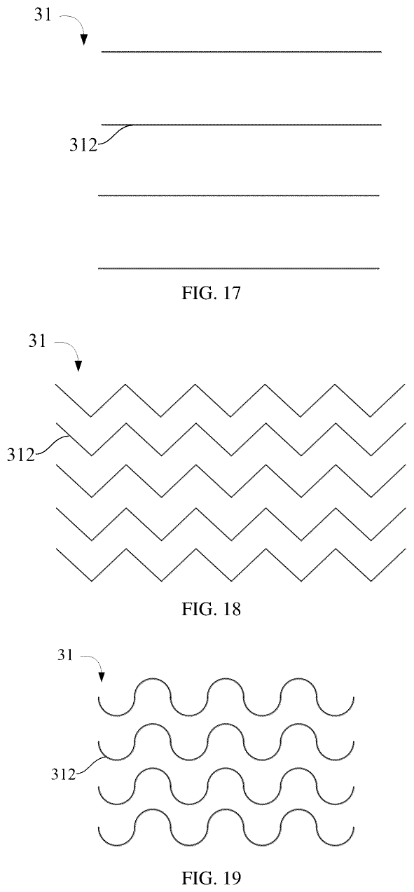

As shown in FIGS. 17 to 19, the shape of the welding mark 31 may be a straight line, a sawtooth line, a wavy line, or other irregular lines, and the like. The number of lines 312 (i.e., a linear welding mark) in a same welding mark 31 may be one, two, three, or four, and the like. Adjacent lines 312 are disconnected, and in a process of forming the lines 312, a formation time of each line 312 has a time interval, and there is a distance gap between each line 312. Disposal of the time interval and the distance gap facilitates heat dissipation in a welding process.

For example, in one line 312, a length of the line 312 may be in a range of 0.01 mm to 6 mm. A design principle of the length of the line 312 is similar to that of the distance R1 from the center of the welding mark 31 to the edge of the welding mark 31, and details are not described herein again.

For example, in one line 312, a width of the line 312 may be in a range of 0.01 mm to 0.2 mm. A design principle of the width of the line 312 is similar to that of the width L6 of the annular line 311, and details are not described herein again.

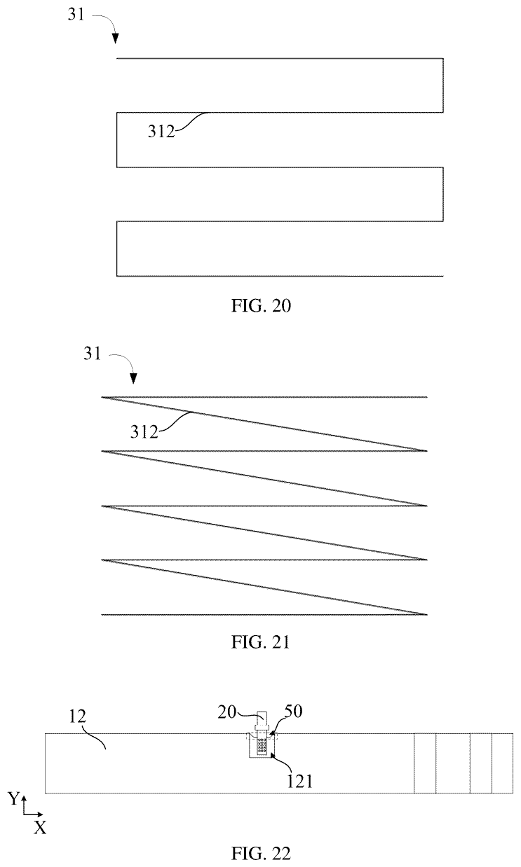

A plurality of lines 312 may be connected together to form a continuous line shown in FIGS. 20 and 21. The plurality of lines 312 are connected together, so that a relatively high welding strength of the welding mark 31 is achieved.

In addition, in related technologies, a region uncoated with active layer may be disposed on an electrode plate, i.e., active material layers on two opposite surfaces of a partial region of a current collector are removed, so that the two opposite surfaces of the current collector are exposed, the region uncoated with active layer is formed, and the region uncoated with active layer is used for welding tabs. However, in a cutting process of the electrode plate, burrs are easily generated at a cutting edge of the current collector. When the two opposite surfaces of the current collector are both covered with the active material layer, the burrs are covered by the active material layer, and therefore, the structural film layer outside the electrode plate may not affect by the burrs. When the region uncoated with active layer is disposed on the electrode plate, the current collector is exposed, so that the burrs at an edge of the current collector are exposed, and the burrs are easy to pierce through an adjacent structural film layer, resulting in a short circuit between positive and negative electrodes of a battery, and further impacting safety of the battery.

In view of the above technical problems, in the electrode plate 100 provided by the embodiments of the present application, a notch 50 is provided at an edge of an exposed current collector 11 of the electrode plate 100, so that at least a part of exposed burrs can be removed to reduce the number of burrs, reducing an impact on an external structural film layer by the burrs, and further improving safety of a battery. The notch 50 may be described in detail below.

In an embodiment of the present application, as shown in FIG. 22, an edge of the electrode plate 100 is provided with the notch 50, and the notch 50 is shown in the dashed box in FIG. 22. The notch 50 is located at an edge of the slot of the groove 121 and penetrates through two opposite surfaces of the electrode plate 100 along the thickness direction of the electrode plate 100 (i.e., the stacking direction of the electrode plates), i.e., both the current collector 11 and the active material layer 12 at the notch 50 are removed, and the notch 50 penetrates through the edge of the electrode plate 100.

Therefore, while the notch 50 is formed, the burrs at the edge of the current collector 11 are removed, reducing the burrs at the edge of the current collector 11 exposed at the groove 121, and further reducing an impact on an external structural film layer by the burrs, so as to improve safety of a battery.

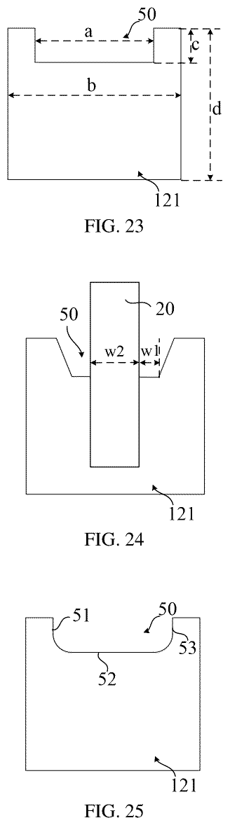

As shown in FIG. 23, along the length direction of the electrode plate 100 (i.e., the second direction X), the notch 50 has an extension length a.

As shown in FIGS. 24, 26 and 27, along the width direction of the electrode plate 100 (i.e., the first direction Y), the extension length a located on a side, away from a center of the groove 121, of the notch 50 is greater than the extension length a located on a side, close to the center of the groove 121, of the notch 50. The extension length a located on the side, away from the center of the groove 121, of the notch 50 is longer, so that more burrs at the edge of the current collector 11 may be removed. The extension length a located on the side, close to the center of the groove 121, of the notch 50 is shorter, so that more current collector 11 may be retained, which may lead to a relatively large contact area between the current collector 11 and the tab 20, increasing a connection strength between the current collector 11 and the tab 20.

As shown in FIGS. 23 and 24, a shape of the notch 50 may be quadrilateral, for example, the shape of the notch 50 may be rectangular or trapezoidal.

As shown in FIG. 25, an inner wall surface of the notch 50 includes a first inner wall section 51, a second inner wall section 52, and a third inner wall section 53 which are connected in sequence, the first inner wall section 51 and the third inner wall section 53 are two inner wall sections disposed at intervals along the second direction X, and the second inner wall section 52 is an inner wall section extending along the first direction Y.

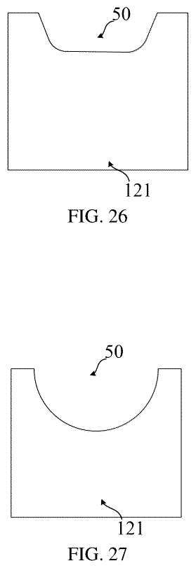

As shown in FIGS. 25 and 26, rounded corners are disposed between the first inner wall section 51 and the second inner wall section 52 and between the second inner wall section 52 and the third inner wall section 53. Along the second direction X, the extension length a of the notch 50 at the rounded corner is less than that of the rest of the notch 50 except for the rounded corner, so that more current collector 11 may be retained. In addition, a corner between two adjacent inner wall sections is disposed as a rounded corner, so that a stress at the corner between the two inner wall sections may be reduced.

For example, a radius of the rounded corner may be in a range of 2 mm to 20 mm. For example, the radius of the rounded corner may be 2 mm, 5 mm, 10 mm, 15 mm, or 20 mm, and the like, which is not limited in the embodiments of the present application. A stress at the rounded corner is relatively uniform when the radius of the rounded corner is within the radius with this range.

In an embodiment in which the shape of the notch 50 is set to be trapezoidal, as shown in FIG. 24 and FIG. 26, a distance between the first inner wall section 51 and the third inner wall section 53 gradually increases along a direction from a center of the first groove 121 to a center of the notch 50 (i.e., the first direction Y).

In an embodiment in which the shape of the notch 50 is set to be rectangular, as shown in FIGS. 23 and 25, a distance between the first inner wall section 51 and the third inner wall section 53 is equal along a direction from a center of the first groove 121 to a center of the notch 50 (i.e., the first direction Y). It may be understood that, as for the shape of the notch shown in FIG. 25, the distance between the first inner wall section 51 and the third inner wall section 53 is equal, and the distance does not include a distance at the rounded corner.

As shown in FIG. 27, the shape of the notch 50 may be semicircular, and the extension length of the notch 50 gradually increases along a direction from a center of the first groove 121 to a center of the notch 50 (i.e., the first direction Y), so that the inner wall surface of the notch 50 is a complete transition arc surface, making an overall stress of the inner wall surface relatively uniform.

As shown in FIG. 23, along the second direction X, a length of the notch 50 (i.e., the longest extension length a) is 0.8 to 1.2 times a length b of the groove 121, i.e., a ratio of the longest extension length a of the notch 50 to the length b of the groove 121 may be in a range of 0.8 to 1.2, which not only avoids excessive burrs at the edge of the current collector 11 caused by the length of the notch 50 being too small, avoiding an impact on safety of a battery, but also avoids a situation that more active material layers 12 are removed caused by the length of the notch 50 being too large, avoiding a relatively large impact on an energy density of a battery. For example, the ratio may be 0.8, 0.9, 1.0, 1.1, or 1.2, and the like, which is not limited in this embodiment of the present application.

As shown in FIG. 23, along the first direction Y, a length c of the notch 50 is 0.01 to 0.3 times a length d of the groove 121, i.e., a ratio of the length c of the notch 50 to the length d of the groove 121 may be in a range of 0.01 to 0.3, which not only avoids inability to effectively remove the burrs caused by the notch 50 being too small, but also avoids a situation that more active material layers 12 are removed, avoiding a relatively large impact on an energy density of a battery. For example, a ratio of the length c of the notch 50 to the length d of the groove 121 may be 0.01, 0.05, 0.1, 0.15, 0.2, or 0.3, and the like, which is not limited in this embodiment of the present application.

As shown in FIG. 24, along the second direction X, a minimum spacing w1 between the tab 20 located in the notch 50 and an inner wall surface of the notch 50 is 0.2 to 0.5 times a width w2 of the tab 20, i.e., a ratio of the minimum spacing w1 to the width w2 of the tab 20 may be in a range of 0.2 to 0.5. When the ratio of the minimum spacing w1 to the width w2 of the tab 20 is within the ratio with this range, an impact of welding the tab 20 on the active material layer 12 at the notch 50 is a relatively small, and in addition, a connection area between the tab 20 and the current collector 11 may also be relatively large. For example, the ratio of the minimum spacing w1 to the width w2 of the tab 20 may be 0.2, 0.3, 0.4, 0.5, and the like, which is not limited in the embodiment of the present application.

A surface, away from the tab 20, of the electrode plate 100 is covered with an insulating adhesive layer, and all edges of the notch 50 are covered by the insulating adhesive layer, so that a side, facing the current collector 11, of the tab 20 may be protected.

A depth of the notch 50 may be in a range of 0.5 mm to 5 mm along the stacking direction of the electrode plates, i.e., a total thickness of the active material layers 12 on both sides of the current collector 11 and the current collector 11 may be in a range of 0.5 mm to 5 mm. For example, the depth of the notch 50 may be 0.5 mm, 1 mm, 2 mm, 3 mm, or 5 mm, which is not limited in this embodiment of the present application.

In addition, an embodiment of the present application further provides a battery, and the battery includes the electrode assembly 1 in the foregoing embodiments.

It should be noted herein that a numerical value and a numerical value range involved in the embodiments of the present application are approximate values, and there may be an error in a certain range due to an effect of a manufacturing process, which may be considered to be ignored by those of ordinary skill in the art.

Finally, it should be noted that: above embodiments are merely used to illustrate the technical solutions of the present application, rather than limiting the technical solutions of the present application; although the present application has been described in detail with reference to the foregoing embodiments, it should be understood by those of ordinary skill in the art that it may still modify the technical solutions recited in the foregoing embodiments, or perform equivalent replacement on some or all of the technical features, and these modifications or replacement do not make the essence of the corresponding technical solutions deviate from the scope of the technical solutions of the embodiments of the present application.

What is claimed is:

1. An electrode assembly, comprising at least two electrode plates stacked on each other, wherein two adjacent electrode plates have opposite polarities, the two adjacent electrode plates comprise a first electrode plate and a second electrode plate, the first electrode plate comprises a first current collector and a first active material layer, the first current collector comprises a first surface and a second surface that are disposed opposite to each other, the first surface and the second surface are covered by the first active material layer, the second electrode plate comprises a second current collector and a second active material layer, the second current collector comprises a third surface and a fourth surface that are disposed opposite to each other, and the third surface and the fourth surface are covered by the second active material layer;
the first electrode plate is provided with a first groove, a slot of the first groove is located on a surface, away from the first current collector, of the first active material layer on the first surface, a bottom wall of the first groove is the first surface, and the first current collector is connected to a first tab in the first groove;
the second electrode plate is provided with a first avoidance groove, a slot of the first avoidance groove is located on a surface, away from the second current collector, of the second active material layer on the fourth surface, a bottom wall of the first avoidance groove is the fourth surface, and the first avoidance groove and the first groove are disposed opposite to each other along a stacking direction of the electrode plates; and
the first tab is completely covered by a projection of the first avoidance groove on the first electrode plate.

2. The electrode assembly according to claim 1, wherein the second electrode plate is provided with a second groove, a slot of the second groove is located on a surface, away from the second current collector, of the second active material layer on the fourth surface, a bottom wall of the second groove is the fourth surface, and the second current collector is connected to a second tab in the second groove;
the first electrode plate is provided with a second avoidance groove, a slot of the second avoidance groove is located on a surface, away from the first current collector, of the first active material layer on the first surface, a bottom wall of the second avoidance groove is the first surface, and the second avoidance groove and the second groove are disposed opposite to each other along the stacking direction of the electrode plates; and
the second tab is completely covered by a projection of the second avoidance groove on the second electrode plate.

3. The electrode assembly according to claim 2, wherein the second electrode plate is further provided with a third avoidance groove, a slot of the third avoidance groove is located on a surface, away from the second current collector, of the second active material layer on the third surface, a bottom wall of the third avoidance groove is the third surface, and along the stacking direction of the electrode plates, the second groove and the third avoidance groove are disposed opposite to each other on the second electrode plate.

4. The electrode assembly according to claim 1, wherein a length of the first groove is less than a length of the first current collector along a first direction of the electrode plate.

5. The electrode assembly according to claim 1, wherein a separator is disposed between every two adjacent electrode plates, a protective layer is disposed between the separator adjacent to the first tab and the first tab, and the first groove is completely covered by the protective layer; and an isolation layer is disposed between the separator adjacent to the first avoidance groove and the first avoidance groove, and the first avoidance groove is completely covered by the isolation layer.

6. The electrode assembly according to claim 5, wherein a portion inserted into the first avoidance groove comprises any one of the followings:
along the stacking direction of the electrode plates, a thickness of the first tab being equal to a depth of the first groove, a portion of the separator, a portion of the protection layer and a portion of the isolation layer that are located between the first avoidance groove and the first groove being all inserted into the first avoidance groove; or
along the stacking direction of the electrode plates, a thickness of the first tab being greater than a depth of the first groove, a portion of the separator, a portion of the protection layer, a portion of the isolation layer and a portion of the first tab that are located between the first avoidance groove and the first groove being all inserted into the first avoidance groove.

7. The electrode assembly according to claim 1, wherein a first direction of the electrode plate is perpendicular to a second direction of the electrode plate, the stacking direction of the electrode plates is perpendicular to both the second direction and the first direction, and a size related to the first avoidance groove comprises at least one of the following sizes:
along the first direction, a length of the first avoidance groove being in a range of 1 mm to 40 mm;
along the second direction, a length of the first avoidance groove being in a range of 1 mm to 30 mm;
along the second direction, the first avoidance groove being located in a middle section of the second electrode plate, and a distance between the first avoidance groove and an end of the second electrode plate being ¼ to ¾ of a length of the second electrode plate;
along the stacking direction of the electrode plates, a depth of the first avoidance groove being in a range of 0.01 mm to 0.2 mm;
along the first direction, a ratio of a length of the first avoidance groove to a length of the first groove being in a range of 0.8 to 1.2; or
along the second direction, a ratio of a length of the first avoidance groove to a length of the first groove being in a range of 0.8 to 1.2.

8. The electrode assembly according to claim 1, wherein the first current collector is welded to the first tab to form a welding mark, and
a positional relationship between the welding mark, the first tab and the first current collector comprises any one of the following relationships:
along the stacking direction of the electrode plates, the welding mark penetrating through the first tab, and the welding mark being located in a partial region, close to the first tab, of the first current collector;
along the stacking direction of the electrode plates, the welding mark penetrating through the first tab and the first current collector, the welding mark located on a side, away from the first tab, of the first current collector protruding toward a side away from the first tab to form a second protrusion, and the second protrusion being covered by the first active material layer located on a side, away from the first groove, of the first current collector; or
the welding mark comprising an outer edge portion and a middle portion, the outer edge portion being annularly disposed on an outer side of the middle portion, and along the stacking direction of the electrode plates, the middle portion penetrating through the first tab and being located in a partial region, close to the first tab, of the first current collector, the outer edge portion penetrating through the first tab and the first current collector, the outer edge portion located on a side, away from the first tab, of the first current collector protruding toward a side away from the first tab to form a second protrusion, and the second protrusion being covered by the first active material layer on a side, away from the first groove, of the first current collector.

9. The electrode assembly according to claim 8, wherein at least a portion of the welding mark is located on a surface, away from the first current collector, of the first tab, and protrudes toward a direction away from the first current collector to form a first protrusion.

10. The electrode assembly according to claim 8, wherein there are a plurality of welding marks, the plurality of welding marks are disposed at intervals and form a welding area, and at least some of the plurality of welding marks have different shapes; the plurality of welding marks are disposed in at least two matrices, and the at least two matrices are disposed in an array;
and in a same matrix, each welding mark has a different shape.

11. The electrode assembly according to claim 10, wherein a first direction of the electrode plate is perpendicular to a second direction of the electrode plate, the stacking direction of the electrode plates is perpendicular to both the second direction and the first direction, and a size related to the welding mark comprises at least one of the following sizes:
along the first direction, the at least two matrixes being disposed at intervals on the first electrode plate, and a ratio of a distance between any two adjacent matrixes to a length of the welding area being in a range of 1% to 25%;
a distance between any two adjacent matrices being less than or equal to 10 mm;
along the first direction, a length of the welding area being less than or equal to 40 mm;
along the second direction, a length of the welding area being less than or equal to 30 mm;
a distance between a center of the welding mark and an outer edge of the welding mark being in a range of 0.05 mm to 2.5 mm; or
along the stacking direction of the electrode plates, a height of the first protrusion being less than or equal to 0.1 mm.

12. The electrode assembly according to claim 1, wherein on the first current collector, a projection of the first groove is within a projection of the first active material layer on the second surface.

13. The electrode assembly according to claim 1, wherein a first direction of the electrode plate is perpendicular to a second direction of the electrode plate, the stacking direction of the electrode plates is perpendicular to both the second direction and the first direction, and a size related to the first groove comprises at least one of the following sizes:
along the first direction, a length of the first groove being in a range of 1 mm to 40 mm;
along the second direction, a length of the first groove being in a range of 1 mm to 30 mm;
along the second direction, the first groove being located in a middle section of the first electrode plate, and a distance between the first groove and an end of the first electrode plate being ⅓ to ⅔ of a length of the first electrode plate;
along the second direction, a distance between an edge of the first tab and a sidewall of the first groove being in a range of 0.001 mm to 5 mm; or
along the stacking direction of the electrode plates, a thickness of the first tab being greater than or equal to a depth of the first groove, a thickness of the first tab being in a range of 0.01 mm to 1 mm, and a depth of the first groove being in a range of 0.01 mm to 0.2 mm.

14. The electrode assembly according to claim 1, wherein an edge of the first groove is provided with a notch, and the notch penetrates through an edge of the first electrode plate along the stacking direction of the electrode plates.

15. The electrode assembly according to claim 14, wherein along a second direction of the electrode plate, the notch has an extension length; and along a first direction of the electrode plate, an extension length located on a side, away from a center of the first groove, of the notch is greater than an extension length located on a side, close to the center of the first groove, of the notch.

16. The electrode assembly according to claim 14, wherein an inner wall surface of the notch comprises a first inner wall section, a second inner wall section, and a third inner wall section which are connected in sequence, and rounded corners are disposed between the first inner wall section and the second inner wall section and between the second inner wall section and the third inner wall section; and radii of the rounded corners are in a range of 2 mm to 20 mm.

17. The electrode assembly according to claim 16, wherein along a direction from a center of the first groove to a center of the notch, a distance relationship between the first inner wall section and the third inner wall section comprises any one of the following relationships:
a shape of the notch being trapezoidal, and a distance between the first inner wall section and the third inner wall section being gradually increased; or
a shape of the notch being rectangular, and a distance between the first inner wall section and the third inner wall section being equal.

18. The electrode assembly according to claim 14, wherein a shape of the notch is semicircular, the notch has an extension length along a second direction of the electrode plate, and the extension length is gradually increased along a direction from a center of the first groove to a center of the notch.

19. The electrode assembly according to claim 14, wherein a first direction of the electrode plate is perpendicular to a second direction of the electrode plate, and a relationship between a size of the notch and a size of the first groove comprises at least one of the following relationships:
along the second direction, a length of the notch being 0.8 to 1.2 times a length of the first groove;
along the first direction, a length of the notch being 0.01 to 0.3 times a length of the first groove; or
along the second direction, a minimum distance between the first tab in the notch and an inner wall surface of the notch being 0.2 to 0.5 times a length of the first tab.

20. A battery, comprising an electrode assembly, the electrode assembly comprising:
at least two electrode plates stacked on each other, wherein two adjacent electrode plates have opposite polarity, the two adjacent electrode plates comprise a first electrode plate and a second electrode plate, the first electrode plate comprises a first current collector and a first active material layer, the first current collector comprises a first surface and a second surface that are disposed opposite to each other, the first surface and the second surface are covered by the first active material layer, the second electrode plate comprises a second current collector and a second active material layer, the second current collector comprises a third surface and a fourth surface that are disposed opposite to each other, and the third surface and the fourth surface are covered by the second active material layer;
the first electrode plate is provided with a first groove, a slot of the first groove is located on a surface, away from the first current collector, of the first active material layer on the first surface, a bottom wall of the first groove is the first surface, and the first current collector is connected to a first tab in the first groove;
the second electrode plate is provided with a first avoidance groove, a slot of the first avoidance groove is located on a surface, away from the second current collector, of the second active material layer on the fourth surface, a bottom wall of the first avoidance groove is the fourth surface, and the first avoidance groove and the first groove are disposed opposite to each other along a stacking direction of the electrode plates; and
the first tab is completely covered by a projection of the first avoidance groove on the first electrode plate.
